(19) United States
(12) Patent Application Publication
(10) Pub. No.: US 2017/0153206 A1
(43) Pub. Date: Jun. 1, 2017

(54) PHOTO ACOUSTIC PROBE AND PHOTO ACOUSTIC MEASUREMENT DEVICE INCLUDING THE SAME

(71) Applicant: Electronics and Telecommunications Research Institute, Daejeon (KR)

(72) Inventors: Joo Yong SIM, Daejeon (KR); Bong Kyu KIM, Daejeon (KR); Chang-Geun AHN, Daejeon (KR)

(21) Appl. No.: 15/360,933

(22) Filed: Nov. 23, 2016

(30) Foreign Application Priority Data
Nov. 27, 2015 (KR) 10-2015-0167779
Jul. 22, 2016 (KR) 10-2016-0093570

(51) Int. Cl. G01N 29/24

(52) U.S. Cl. CPC G01N 29/2418

(57) ABSTRACT

Provided are a photo acoustic probe and a photo acoustic measurement device including the same. The photo acoustic probe includes a stage configured to receive a sample, a light source configured to provide light to the sample, a housing having an optical opening part and provided on the stage around the sample, a sound reception part disposed on one side inner wall of the housing to receive a sound induced from the sample, and a sound reflection part disposed in the optical opening part of the housing to transmit light and reflect sound to the sound reception part.

### CROSS-REFERENCE TO RELATED APPLICATIONS

This U.S. non-provisional patent application claims priority under 35 U.S.C. §119 of Korean Patent Application Nos. 10-2015-0167779, filed on Nov. 27, 2015 and 10-2016-0093570, filed on Jul. 22, 2016, the entire contents of which are hereby incorporated by reference.

### BACKGROUND

The present disclosure herein relates to a property analysis device, and more particularly, to a photo acoustic probe for detecting sound by using light and a photo acoustic measurement device including the same.

In general, a photo acoustic device provides light to a sample and receives an acoustic signal from the sample. The photo acoustic device may calculate the light absorption rate of a material by comparing the intensity of an acoustic signal. The light absorption rate may vary according to the type or material of a sample. Additionally, the light absorption rate may vary according to a measurement environment. Due to this, a photo acoustic device requires calibration each time a sample is measured.

### SUMMARY

The present disclosure provides a photo acoustic probe capable of simultaneously receiving sounds of a reference sample and a measured sample as a single light.

The present disclosure also provides a photo acoustic measurement device capable of performing self-calibration on a photo acoustic probe.

An embodiment of the inventive concept provides a photo acoustic probe including: a stage configured to receive a plurality of samples; a light source configured to provide a light to the samples; a housing having an optical opening part between the light source and the sample and disposed on the stage around the sample; a sound reception part disposed on an inner wall of the housing in the optical opening part to receive a sound induced from the samples by the light; and a space division part provided in the optical opening part and configured to divide the optical opening part of the housing to form sound propagation spaces of the plurality of samples in the housing.

In an embodiment of the inventive concept, a photo acoustic measurement device includes: a photo acoustic probe; and a computer connected to the photo acoustic prove, wherein the photo acoustic probe includes: a stage configured to receive a plurality of samples; a light source configured to provide a light to the samples; a housing having an optical opening part between the light source and the sample and disposed on the stage around the sample; a sound reception part disposed on an inner wall of the housing in the optical opening part to receive a sound induced from the samples by the light; and a space division part provided in the optical opening part and configured to divide the optical opening part of the housing to form sound propagation spaces of the plurality of samples in the housing.

In an embodiment of the inventive concept, a photo acoustic measurement device includes: a light source configured to generate a light; a stage configured to receive a target sample and reference samples that are to generate sound by the light; a housing disposed on the stage and having a space division part between the target sample and the reference sample; a light splitting part configured to split the light to be delivered to the target sample and the reference samples; at least one sound reception part disposed in the housing and configured to receive a sound generated from the target sample and the reference samples; and a data processing module configured to correct a target sound signal generated from the target sample according to a reference signal generated from the reference sample.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a view illustrating a photo acoustic measurement device according to an embodiment of the inventive concept;

FIG. 2A is a graph illustrating a sound signal of a reference sample and a sound signal of a measured sample of FIG. 1;

FIG. 2B is a graph illustrating a generalized sound signal of a reference sample and a generalized sound signal of a measured sample of FIG. 1;

FIGS. 3 and 4 are views illustrating a photo acoustic measurement device of FIG. 1;

FIG. 5 is a view illustrating one example of a photo acoustic measurement device of FIG. 1;

FIGS. 6 and 7 are views illustrating one example of a photo acoustic measurement device of FIG. 5; and

FIG. 8 is a flowchart illustrating a method of obtaining a target sound signal of a photo acoustic measurement device of FIG. 1.

### DETAILED DESCRIPTION

Hereinafter, preferred embodiments of the inventive concept will be described in detail with reference to the accompanying drawings. Advantages and features of the inventive concept, and implementation methods thereof will be clarified through following embodiments described with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art and the inventive concept is only defined by the scope of the claims. Like reference numbers refer to like elements throughout the entire specification.

The terms used in this specification are used only for explaining specific embodiments while not limiting the present invention. The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components. Additionally, in the specification, a light source, a housing, reflection, and transmission may be understood as meaning mainly used in the optical field. Since it is according to a preferred embodiment, reference numerals suggested in the order of description are not necessarily limited to the order.

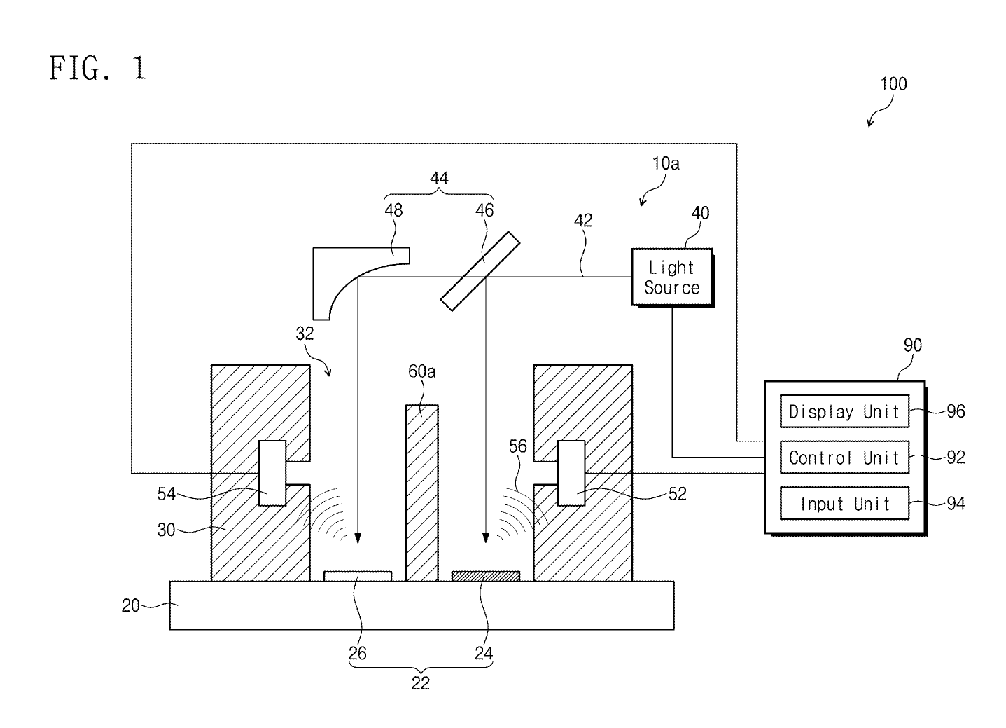

FIG. 1 is a view illustrating a photo acoustic measurement device 100 according to an embodiment of the inventive concept.

Referring to FIG. 1, the photo acoustic measurement device 100 may include a photo acoustic probe 10a and a computer 90. The photo acoustic probe 10a may provide a light 42 to a plurality of samples 22 and receive a sound 56 from the samples 22. The computer 90 may analyze the plurality of samples 22 by using the received sound 56.

The samples 22 may be provided in the photo acoustic probe 10a. In an exemplary embodiment, the photo acoustic probe 10a may include a stage 20, a housing 30, a light source 40, first and second microphones 52 and 54, and a space division part 60a.

The stage 20 may receive the samples 22. The stage 20 may move the samples 22 horizontally. In an exemplary embodiment, the samples 22 may include a reference sample 24 and a target sample 26. For example, the reference sample 24 may have a predetermined reference light absorption rate. The computer 90 may store the reference light absorption rate of the reference sample 24. Alternatively, the reference light absorption rate may be inputted from the outside to the computer 90. The target sample 26 may have a light absorption rate compared to the reference light absorption rate as a target to be measured. The target sample 26 may include blood or biological tissue. Alternatively, the target sample 26 may include a material or a mechanical device.

The housing 30 may be provided on the stage 20. In an exemplary embodiment, the housing 30 may have an optical opening part 32. The samples 22 may be provided on the stage 20 in the optical opening part 32. For example, the housing 30 may include a plastic casing or a ceramic block.

The light source 40 may generate the light 42. For example, the light source 40 may include a laser device. The light 42 may include laser beam. The light 42 may be provided to the samples 22. Optical system 44 may be disposed between the sample 22 and the light source 40. The optical system 44 may provide the light 42 to the samples 22 separately. In an exemplary embodiment, the optical system 44 may include a first mirror 46 and a second mirror 48. The first mirror 46 may be disposed between the light source 40 and the reference sample 24. For example, the first mirror 46 may include a half mirror. The first mirror 46 may transmit a part of the light 42 to the second mirror 48 and reflect the remaining part of the light 42 to the reference sample 24. The second mirror 48 may be disposed between the first mirror 46 and the target sample 26. The second mirror 48 may change a path of the light 42 between the first mirror 46 and the target sample 26. The light 42 may be incident to the target sample 26. The light 42 may be provided to the reference sample 24 and the target sample 26 as the same energy. The reference sample 24 and the target sample 26 may cause thermoelastic expansion instantaneously and may emit the sound 56 of ultrasonic or electromagnetic waves.

The first and second microphones 52 and 54 may be respectively disposed on the inner walls at the both sides of the housing 30 facing the space division part 60a in the optical opening part 32. The first and second microphones 52 and 54 may be sound reception parts for receiving the sound 56 of the reference sample 24 and the target sample 26. The first microphone 52 may receive the sound 56 of the reference sample 24. The second microphone 54 may receive the sound 56 of the target sample 26.

The space division part 60a may be disposed on the stage 20 at the center of the optical opening part 32. The space division part 60a may be disposed between the samples 22. In an exemplary embodiment, the space division part 60a may include a first partition wall in the optical opening part 32. The space division part 60a may bisect the optical opening part 32 in a vertical direction. The space division part 60a may provide the same space environment with respect to the sound 56 of the reference sample 24 and the target sample 26. For example, the optical opening part 32 may be divided into a plurality of holes by the space division part 60a. The holes may correspond to propagation spaces of sound. Accordingly, the space division part 60a may provide the same sound propagation space to the reference sample 24 and the target sample 26.

The computer 90 may be connected to the first and second microphones 52 and 54 and the light source 40. In an exemplary embodiment, the computer 90 may include a control unit 92, an input unit 94, and a display unit 96.

The control unit 92 may calculate a measurement error of the photo acoustic probe 10a from a reference light absorption rate by receiving a sound signal of the first microphone 52. Ideally, there is no measurement error of the photo acoustic probe 10a. The control unit 92 may perform self-calibration on the photo acoustic probe 10a by using a measurement error. Accordingly, the control unit 92 may calculate a measured light absorption rate of the target sample 26 by reflecting a measurement error.

The input unit 94 may provide variable values to the control unit 92. For example, an operator may input variable values to the input unit 94. The variable values may be data for controlling an energy value of the light 42 of the light source 40.

The display unit 96 may display input information of the input unit 94 and an energy value of the light 42. The display unit 96 may display a reference light absorption rate, a measured light absorption rate, and a deviation. Alternatively, the display unit 96 may display receptions signals of the first and second microphones 52 and 54 according to the intensity of the sound 56. The display unit 96 may display the intensity of the sound 56 as a color image.

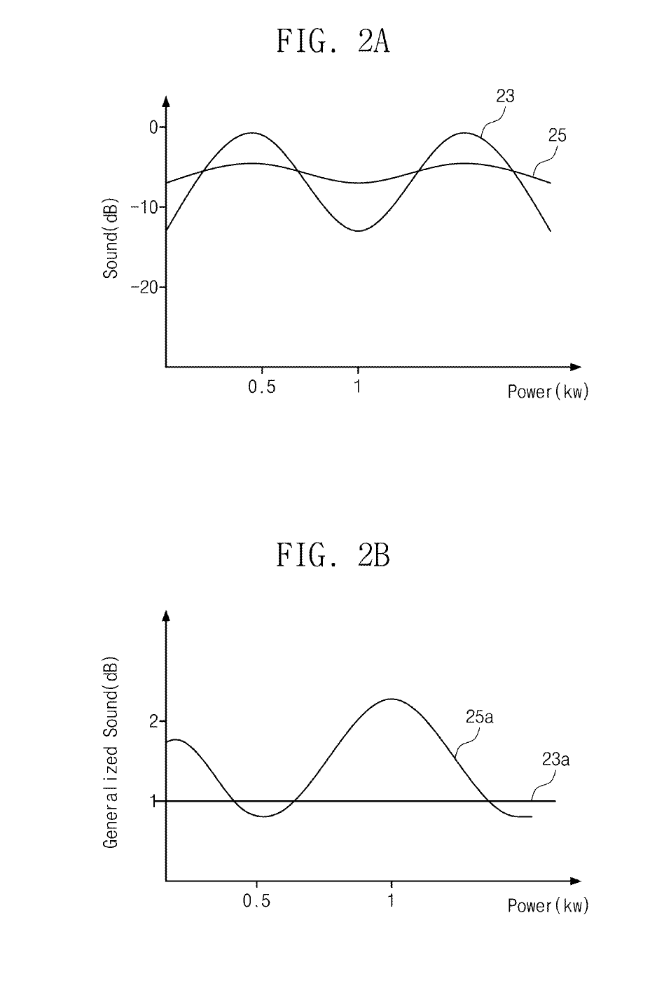

FIG. 2A shows a reference sound signal 23 of the reference sample 24 shown in FIG. 1 and a target sound signal 25 of a target sample 26. FIG. 2B shows a generalized sound signal 23a of the reference sample 24 shown in FIG. 1 and a generalized sound signal 25a of a target sample 26.

Referring to FIG. 2A, the control unit 92 may obtain the reference sound signal 23 of the reference sample 24 and the target sound signal 25 of the target sample 26 through the first and second microphones 52 and 54. The reference sound signal 23 of the reference sample 24 and the target sound signal 25 of the target sample 26 may have noise according to an external environment of the photo acoustic measurement device 100.

Referring to FIGS. 2A and 2B, the control unit 92 may calculate the generalized sound signal 23a of the reference sample 24 and the generalized sound signal 25a of the target sample 26 from the reference sound signal 23 of the reference sample 24 and the target sound signal 25 of the target sample 26. The generalized sound signal 23a of the reference sample 24 and the generalized sound signal 25a of the target sample 26 may remove noise of the reference sound signal 23 of the reference sample 24 and the target sound signal 25 of the target sample 26 according to an external environment of the photo acoustic measurement device 100.

For example, the generalized sound signal 25a of the target sample 26 may have a peak value with respect to 1 KW power. The control unit 92 may receive information on a corresponding material or disease agent having a peak value with respect to 1 KW power from a database (not shown). The control unit 92 may determined the target sample 26 as a corresponding material or disease agent and display the target sample 26 as a corresponding material or disease agent through the display unit 96.

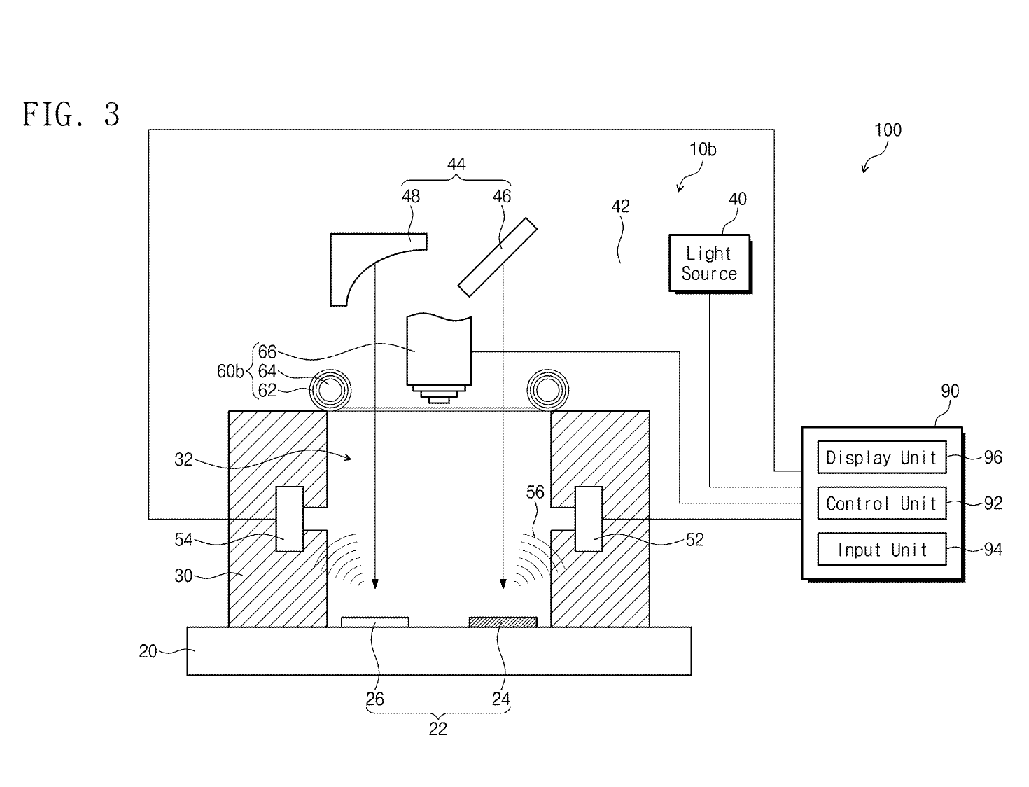

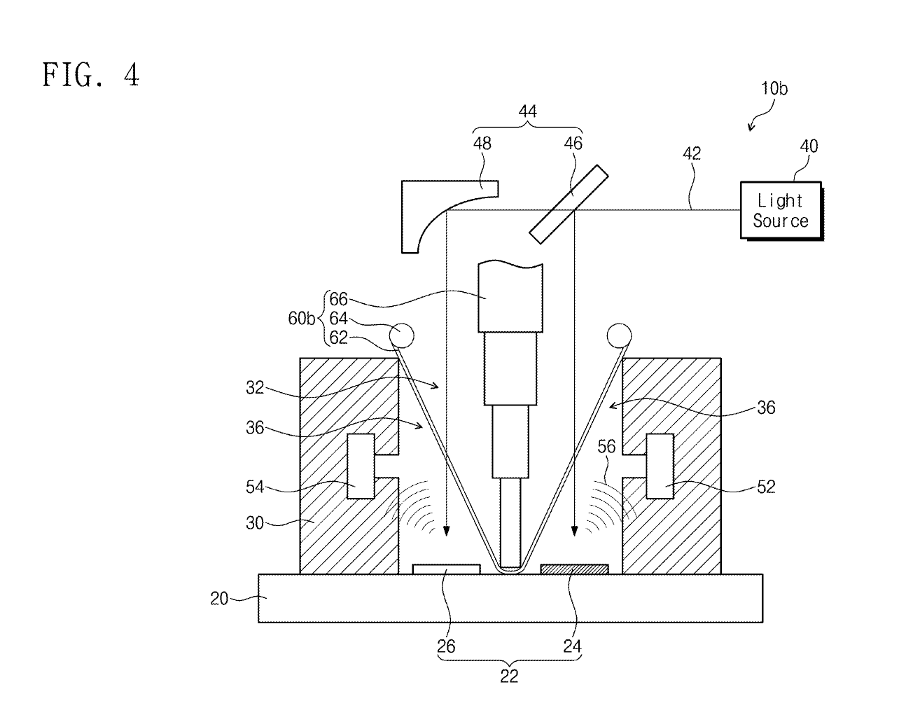

FIGS. 3 and 4 illustrate a photo acoustic probe 10b that is one example of the photo acoustic probe 10a of FIG. 1.

Referring to FIGS. 3 and 4, the space division part 60b of the photo acoustic probe 10b may divide the optical opening part 32 dynamically. In an exemplary embodiment, the space division part 60b may include a sound reflection part 62, winding rollers 64, and a pusher 66.

Referring to FIG. 3, the sound reflection part 62 may cover the optical opening part 32. The both sides of the sound reflection part 62 may be disposed on the housing 30 by the winding rollers 64. The sound reflection part 62 may transmit the light 42. For example, the sound reflection part 62 may include a polymer film.

Referring to FIG. 4, the sound reflection part 62 may be provided to the inside from the upper part of the optical opening part 32 by the pusher 66. The sound reflection part 62 may reflect the sound 56 to the first and second microphones 52 and 54. The sound reflection part 62 may divide the optical opening part 32 into a plurality of propagation spaces 36. The propagation spaces 36 may have the same size. For example, the size of the propagation spaces 36 may be ½ of the size of the optical opening part 32. The propagation spaces 36 may deliver the sound 56 more efficiently than the optical opening part 32.

The winding rollers 64 may be disposed on the housing 30 outside the optical opening part 32. The winding rollers 64 may wind the sound reflection part 62. When the sound reflection part 62 is disposed on the optical opening part 32 as shown in FIG. 3, the winding rollers 64 may wind the sound reflection part 52 to the maximum. When the sound reflection part 62 contacts the stage 20 between the samples 22 as shown in FIG. 3, the winding rollers 64 may unwind the sound reflection part 52 to the maximum.

The pusher 66 may be disposed on the center of the sound reflection part 62. The pusher 66 may be disposed between the sound reflection part 62 and the optical system 44. The pusher 66 may be connected to the control unit 92 of the computer 90. The pusher 66 may lower the sound reflection part 62 from the upper part of the optical opening part 32 to the inside in response to a control signal of the control unit 92. The winding rollers 64 may release the sound reflection part 62. The sound reflection part 62 may be provided in a V-shape in the optical opening part 32. The pusher 66 and the sound reflection part 62 may form the propagation spaces 36 of the sound 56. When the pusher 66 rises, the sound reflection part 62 may rise to the upper part of the optical opening part 32. The winding rollers 64 may wind the sound reflection part 62.

The stage 20, the housing 30, the light source 40, the optical system 44, the first and second microphones 52 and 54, and the input unit 94 and the display unit 96 of the computer 90 may be configured identical to FIG. 1.

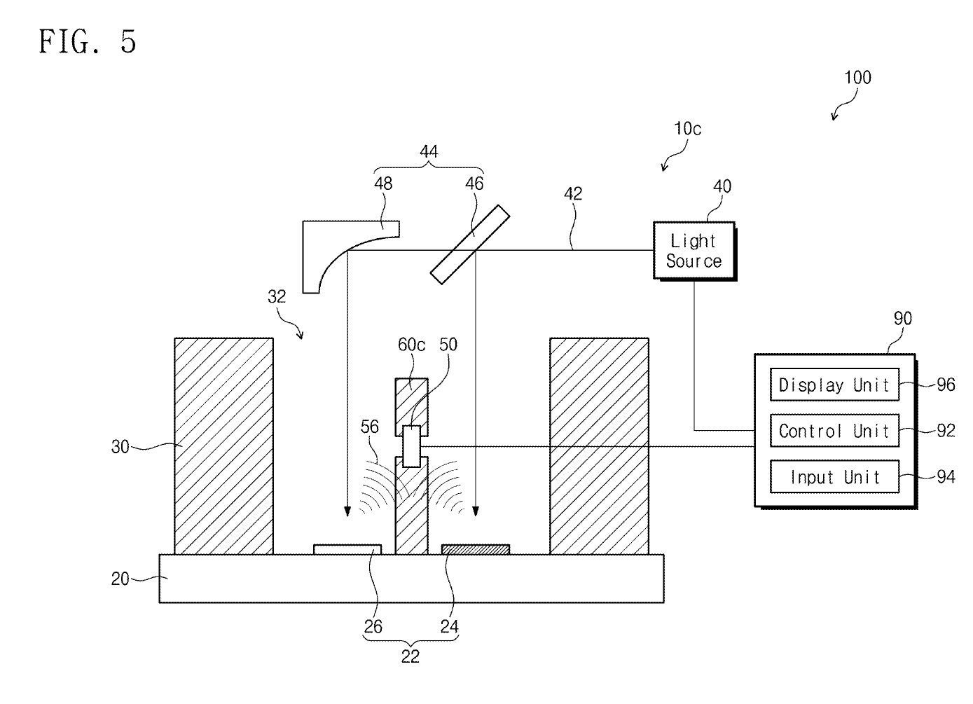

FIG. 5 illustrates a photo acoustic probe 10c that is one example of the photo acoustic probe 10a of FIG. 1.

Referring to FIG. 5, the space division part 10c may include a space division part 60c for fixing a sound reception part 50 at the center of the optical opening part 32. In an exemplary embodiment, the space division part 60c may include a second partition wall. The space division part 60c may be disposed on the stage 20 at the center of the optical opening part 32.

The sound reception part 50 may be exposed to the both sides of the space division part 60c. For example, the sound reception part 50 may include a microphone. The sound reception part 50 may commonly receive a sound 56 of a reference sample 24 and a target sample 26. The sound reception part 50 may be connected to the computer 90.

The stage 20, the housing 30, the light source 40, the optical system 44, and the computer 90 may be configured identical to FIG. 1.

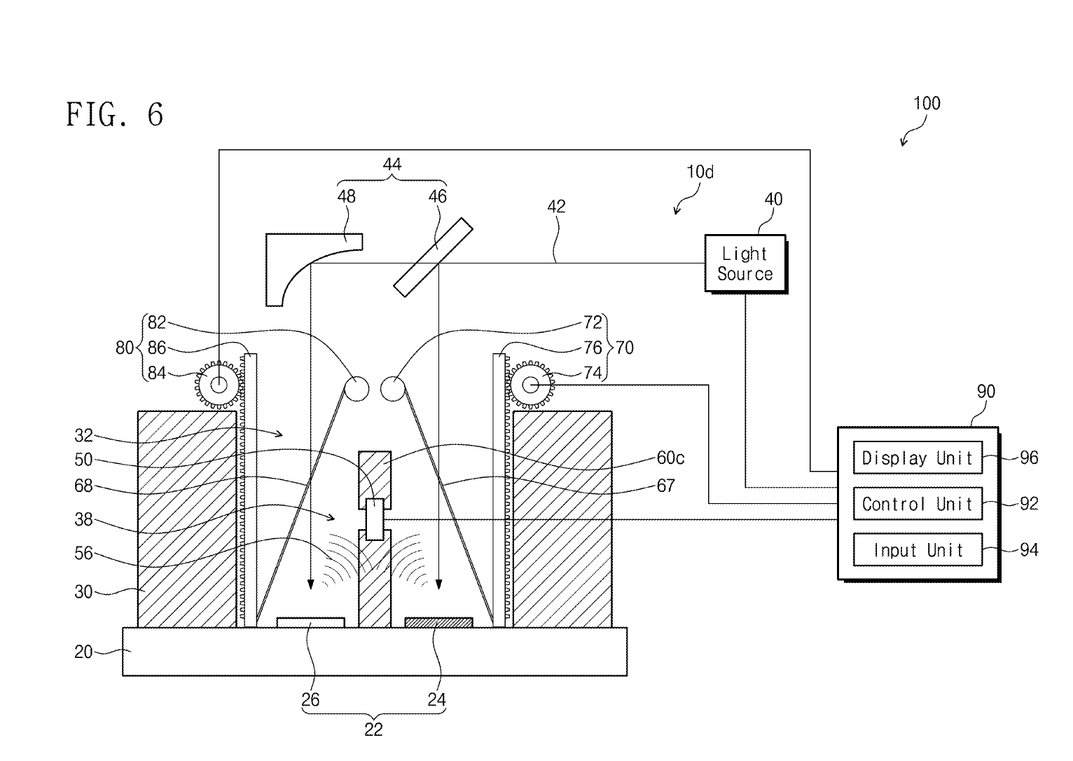

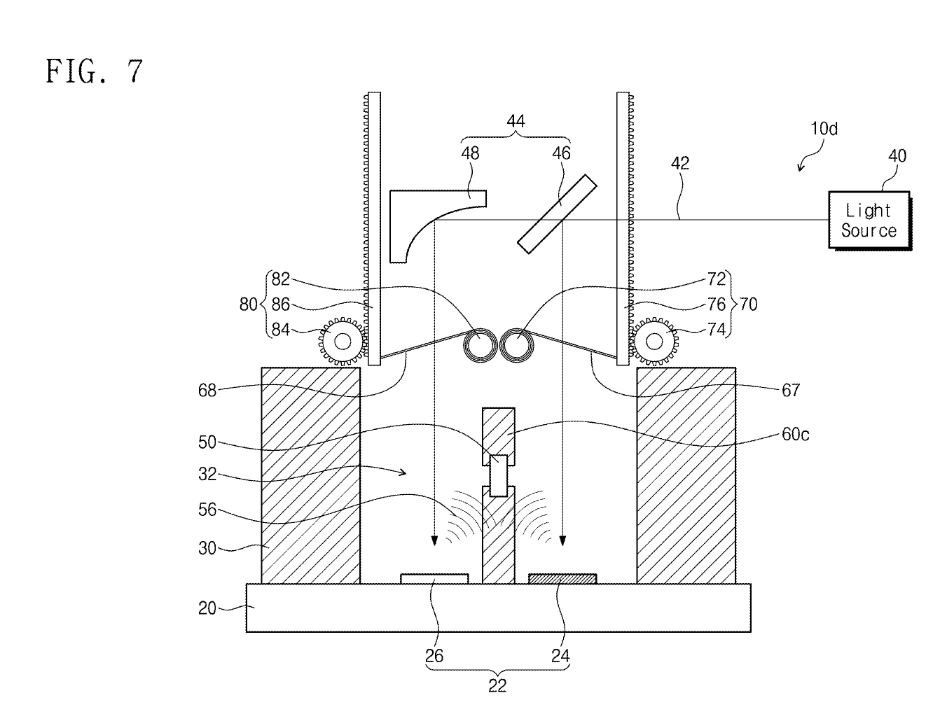

FIGS. 6 and 7 illustrate a photo acoustic probe 10d that is one example of the photo acoustic probe 10c of FIG. 5.

Referring to FIGS. 6 and 7, the photo acoustic probe 10d may include first and second sound reflection parts 67 and 68 and first and second reflection adjusters 70 and 80.

The first and second sound reflection parts 67 and 68 may be respectively disposed on a reference sample 24 and a target sample 26 in an optical opening part 32. The first and second sound reflection parts 67 and 68 may be symmetrically disposed at both sides of the space division part 60c. The first and second sound reflection parts 67 and 68 may form sound propagation spaces 38 at both sides of the space division part 60c. The first and second sound reflection parts 67 and 68 may reflect the sound 56 of the reference sample 24 and the target sample 26 to the sound reception part 50. Since the size of sound propagation spaces 38 is smaller than that of the optical opening part 32, the sound 56 of the reference sample 24 and the target sample 26 may be efficiently delivered to the sound reception part 50 through the sound propagation spaces 38. Each of the first and second sound reflection parts 67 and 68 may include a polymer film.

The first and second reflection adjusters 70 and 80 may adjust a reflection angle of the sound 56 of the first and second sound reflection parts 67 and 68. For example, the first and second reflection adjusters 70 and 80 may identically adjust an inclination angle of the first and second sound reflection parts 67 and 68 with respect to the stage based on the space division part 60c.

In an exemplary embodiment, the first reflection adjuster 70 may include a first winding roller 72, a first gear motor 74, and a first rack gear 76. The first winding roller 72 may be disposed on the space division part 60c. The first winding roller 72 may be connected to one side of the first sound reflection part 67. The first winding roller 72 may wind the first sound reflection part 67. The first gear motor 74 may be disposed on the housing 30 adjacent to the reference sample 24. The first gear motor 74 may rotate. The first rack gear 76 may be coupled to the first gear motor 74. The first rack gear 76 may move along one side inner wall of the optical opening part 32 by the rotation of the first gear motor 74. The first rack gear 76 may be connected to the other side of the first sound reflection part 67. The other side of the first sound reflection part 67 may move from the upper part of the optical opening part 32 to the stage 20 by the first rack gear 76. The first sound reflection part 67 may be disposed in a diagonal direction. The second reflection adjuster 80 may be disposed symmetric to the first reflection adjuster 70 based on the space division part 60c. In an exemplary embodiment, the second reflection adjuster 80 may include a second winding roller 82, a second gear motor 84, and a second rack gear 86. The second winding roller 82 may be disposed on the space division part 60c. The second winding roller 82 may be connected to one side of the second sound reflection part 68. The second winding roller 82 may wind the second sound reflection part 68. The second gear motor 84 may be disposed on the housing 30 adjacent to the target sample 26. The second gear motor 84 may rotate. The second rack gear 86 may move along the other side inner wall of the optical opening part 32 by the rotation of the second gear motor 84. The second rack gear 86 may be connected to the other side of the second sound reflection part 68. The second sound reflection part 68 may move from the upper part of the optical opening part 32 to the stage 20 by the second rack gear 86. The first and second sound reflection parts 67 and 68 may be disposed in an A-shape.

The first and second gear motors 74 and 84 of the first and second reflection adjusters 70 and 80 may be connected to the computer 90. The computer 90 may control the rotations of the first and second gear motors 74 and 84. For example, the computer 90 may control the rotations of the first and second gear motors 74 and 84 to allow the inclination angles of the first and second sound reflection parts 67 and 68 to be identical to each other. The sizes of the sound propagation spaces 38 at both sides of the space division part 60c may be identical to each other.

The stage 20, the housing 30, the light source 40, the optical system 44, the sound reception part 50, the space division part 60c, and the computer 90 may be configured identical to FIG. 4.

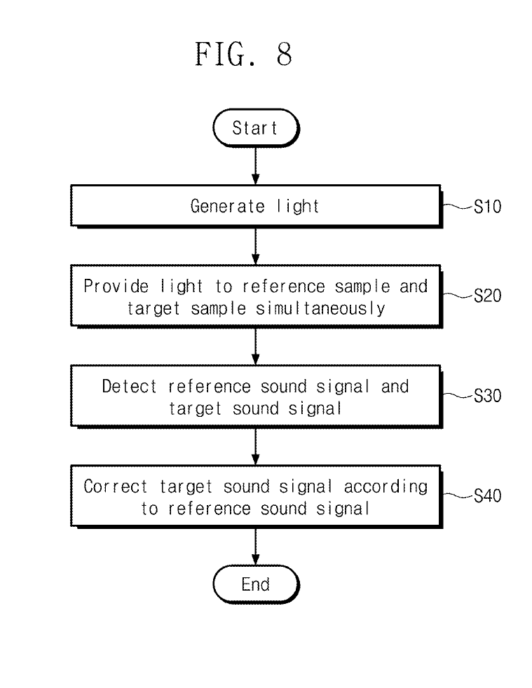

FIG. 8 illustrates a method of obtaining the target sound signal 23 of the photo acoustic measurement device 100 of FIG. 1.

Referring to FIG. 8, the method of obtaining the target sound signal 23 may include generating the light 42 in operation S10, providing the light 42 simultaneously in operation S20, detecting the reference sound signal 23 and the target sound signal 25 in operation S30, and correcting the target sound signal 25 in operation S40.

First, the light source 40 may generate the light 42 in operation S10.

Then, the light source 40 and the optical system 44 may provide the light 42 to the reference sample 24 and the target sample 26 at the same time in operation S20. The reference sample 24 and the target sample 26 may generate sound.

Then, the first and second microphones 52 and 54 may detect sound and the control unit 92 may detect the reference sound signal 23 and the target sound signal 25 in operation S30.

Lastly, the control unit 92 may correct the target sound signal 25 according to the reference sound signal 23 in operation S40. The reference sound signal 23 may reflect external conditions. For example, the reference sound signal 23 may have noise according to external conditions. The control unit 92 may remove noise in the target sound signal 25 by using the reference sound signal 23. Additionally, a measurement error of the target sound signal 25 may be corrected by the reference sound signal 23.

As mentioned above, a photo acoustic probe according to the concept of the inventive concept may include a space division part and a sound reception part in an optical opening part of a housing. The sound reception part may receive sounds of a reference sample and a measured sample at both sides of the space division part. A computer may calculate a measurement error of a photo acoustic probe from sound of a reference sample and a reference light absorption rate. A computer may perform self correction on a photo acoustic probe by using a measurement error. A computer may calculate a measured light absorption rate of a measured sample where a measurement error is reflected.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A photo acoustic probe comprising:
a stage configured to receive a plurality of samples;
a light source configured to provide a light to the samples;
a housing having an optical opening part between the light source and the sample, the housing disposed on the stage around the sample;
a sound reception part disposed on an inner wall of the housing in the optical opening part to receive a sound induced from the samples by the light; and
a space division part provided in the optical opening part and configured to divide the optical opening part of the housing to form sound propagation spaces of the plurality of samples in the housing.

2. The photo acoustic probe of claim 1, wherein the sound reception part comprises first and second microphones disposed on inner walls at both sides of the housing.

3. The photo acoustic probe of claim 2, wherein the space division part comprises a first partition wall disposed on the stage at a center of the optical opening part.

4. The photo acoustic probe of claim 2, wherein the space division part comprises a sound reflection part provided in the optical opening part to transmit the light, the sound reflection part reflecting the sound of the plurality of samples to the first and second microphones.

5. The photo acoustic probe of claim 4, wherein the sound reflection part is provided with a V-shape in the optical opening part.

6. The photo acoustic probe of claim 4, wherein the space division part comprises:
a plurality of winding rollers disposed on the housing outside the optical opening part and configured to wind the sound reflection part; and
a pusher disposed on the sound reflection part between the plurality of winding rollers and providing a center of the sound reflection part to the stage through the optical opening part.

7. The photo acoustic probe of claim 3, wherein the sound reflection part comprises a polymer film.

8. The photo acoustic probe of claim 1, wherein the space division part comprises a second partition wall configured to fix the sound reception part at a center of the opening par and separate the optical opening part spatially.

9. The photo acoustic probe of claim 8, further comprising:
a first sound reflection part configured to reflect the sound generated from one of the plurality of samples to the sound reception part; and
a second sound reflection part symmetrically disposed into the first sound reflection part around the second partition wall and configured to reflect the sound generated from one of the remaining of the plurality of samples to the sound reception part.

10. The photo acoustic probe of claim 9, further comprising:
a first sound reflection adjuster configured to reduce a delivery space of the sound of one of the samples by adjusting an inclination of the first sound reflection part with respect to the stage; and
a second sound reflection adjuster symmetrically disposed to the first sound reflection adjuster and configured to reduce a delivery space of the sound of one of the remaining of the samples by adjusting an inclination of the second sound reflection part with respect to the stage.

11. The photo acoustic probe of claim 10, wherein the first sound reflection adjuster comprises:
a first winding roller disposed on the second partition wall and connected to one side of the first sound reflection part;
a first gear motor disposed on one side of the housing adjacent to the optical opening part; and
a first rack gear coupled to the first gear motor and configured to move the other side of the first sound reflection part along one side inner wall of the housing in the optical opening part by a rotation of the first gear motor.

12. The photo acoustic probe of claim 10, wherein the second sound reflection adjuster comprises:
a second winding roller disposed on the second partition wall and connected to one side of the second sound reflection part;
a second gear motor disposed on the other side of the housing adjacent to the optical opening part; and
a second rack gear coupled to the second gear motor and configured to move the other side of the second sound reflection part along the other side inner wall of the housing in the optical opening part by a rotation of the second gear motor.

13. The photo acoustic probe of claim 9, wherein the first and second sound reflection parts are disposed with A-shape in the optical opening part.

14. The photo acoustic probe of claim 1, further comprising an optical system disposed between the light source and the optical opening part to provide the light of the same intensity to the plurality of samples.

15. A photo acoustic measurement device comprising:
a photo acoustic probe; and
a computer connected to the photo acoustic prove,
wherein the photo acoustic probe comprises:
a stage configured to receive a plurality of samples;
a light source configured to provide a light to the samples;
a housing having an optical opening part between the light source and the sample and disposed on the stage around the sample;
a sound reception part disposed on an inner wall of the housing in the optical opening part to receive a sound induced from the samples by the light; and
a space division part provided in the optical opening part and configured to divide the optical opening part of the housing to form sound propagation spaces of the plurality of samples in the housing.

16. The photo acoustic measurement device of claim 15, wherein the space division part comprises:
a sound reflection part provided on the optical opening part;
a plurality of winding rollers disposed on the housing outside the optical opening part and configured to wind both sides of the sound reflection part; and
a pusher disposed on the sound reflection part between the plurality of winding rollers and configured to provide the sound reflection part to the inside of the optical opening part,
wherein the computer controls the pusher to provide a center of the sound reflection part to the stage between the samples.

17. The photo acoustic measurement device of claim 15, wherein the space division part comprises a partition wall disposed on the stage at a center of the optical opening part and configured to fix the sound reception part, further comprising first and second sound reflection parts disposed in the optical opening part at both sides of the partition wall to reflect a sound of the samples to the sound reception part.

18. The photo acoustic measurement device of claim 17, further comprising first and second reflection adjusters configured to adjust inclination angles of the first and second sound reflection parts, wherein the computer controls the first and second reflection adjusters to allow the inclination angles of the first and second sound reflection parts to be identical to each other.

19. A photo acoustic measurement device comprising:
a light source configured to generate light;
a stage configured to receive a target sample and reference samples that are to generate sound by the light;
a housing disposed on the stage and having a space division part between the target sample and the reference sample;
a light splitting part configured to split the light to be delivered to the target sample and the reference samples;
at least one sound reception part disposed in the housing and configured to receive a sound generated from the target sample and the reference samples; and
a data processing module configured to correct a target sound signal generated from the target sample according to a reference signal generated from the reference sample.
